(19) United States
(12) Patent Application Publication
(10) Pub. No.: US 2002/0160647 A1
(43) Pub. Date: Oct. 31, 2002

(54) Plug for computer or the like

(76) Inventor: Sung Chiang Wu, Chong Ho City (TW)

Correspondence Address: Sung Chiang Wu, P.O. Box 10-69, Chong Ho, Taipei, 235, TW

(21) Appl. No.: 10/172,518

(22) Filed: Jun. 11, 2002

Related U.S. Application Data
(63) Continuation of application No. 09/982,891, filed on Oct. 22, 2001.
Application No. 09/982,891 is a continuation-in-part of application No. 09/501,286, filed on Feb. 9, 2000, now abandoned.

(51) Int. Cl. H01R 13/627

(52) U.S. Cl. 439/359

(57) ABSTRACT

A plug device for an electric facility includes a front portion having one or more prongs or plugs for plugging to the electric facility and having four L-shaped forwardly extending legs for engaging with the electric facility and for stably attaching the plug device onto the electric facility. One or more fasteners may secure the plug device to the electric facility. The rear portion of the plug device includes one or more sockets for receiving and for engaging various kinds of plugs or includes one or more electric wires coupled to the plug device.

The present invention is a continuation application of U.S. patent application Ser. No. 09/982,891, filed on Oct. 22, 2001, abandoned; which is a continuation-in-part of U.S. patent application Ser. No. 09/1501,286, filed on Feb. 09, 2000, abandoned.

### BACKGROUND OF THE INVENTION

1. Field of the Invention

The present invention relates to a plug, and more particularly to a plug for a computer.

2. Description of the Prior Art

Various kinds of typical plug connector devices have been developed for coupling electric facilities to the computers, and comprise a front portion having a number of prongs or sockets or plugs for engaging into the corresponding sockets of the computer. Two fasteners are engaged through the plug connector device and threaded to the computer for securing the electric facilities to the computer. U.S. Pat. No. 4,220,391to Krolak et al., U.S. Pat. No. 5,217,394 to Ho, U.S. Pat. No. 5,406,450 to Shieh, U.S. Pat. No. 5,411,401 to Chiou, U.S. Pat. No. 5,975,953 to Peterson, and U.S. Pat. No. 6,059,599 to Huang, disclose six of the typical plug connector devices for computers. However, the prongs are extended forwardly from the plug connector devices and include a relatively smaller area than that of the front portion of the plug connector devices, such that the plug connector devices may not be stably attached or engaged onto the computer and such that the prongs may have a good chance to be contorted or twisted relative to the plug connector devices.

U.S. Pat. No. 5,419,717 to Abendschein et al. discloses the other typical plug connector device including two prongs or plugs for engaging into the sockets of the computers or the like. The prongs or the plugs also include a relatively smaller area than that of the front portion of the plug connector devices, and also may have a good chance to be contorted or twisted relative to the plug connector devices.

U.S. Pat. No. 5,480,329 to Karlstrom et al. discloses the further typical plug connector device including two housing parts each having a receptacle projection extended forwardly therefrom for engaging with the computers or the like. However, the front portion of the plug connector device has no prongs or plugs for plugging to the other electric facilities. In addition, the receptacle projections of the housing parts are longitudinal and are in line contact with the electric facilities.

The present invention has arisen to mitigate and/or obviate the afore-described disadvantages of the conventional plugs for computers.

### SUMMARY OF THE INVENTION

The primary objective of the present invention is to provide a plug having one or more prongs and four corner legs extended from the front portion for forming a stable structure to stably engage with the computer.

The other objective of the present invention is to provide a plug having one or more sockets provided in the rear portion for receiving various plugs, and simultaneously having a cable provided in the rear portion for coupling to the other electric facilities.

In accordance with one aspect of the invention, there is provided a plug device for an electric facility, the plug device comprising a plug body including a front portion, a rear portion, an upper surface, a lower surface, and two side surfaces, the plug body including four corners having four legs extended forwardly from the four corners thereof respectively for engaging with the electric facility, the legs each including an L-shaped cross section having a pair of limbs perpendicular to each other respectively, and the limbs of the legs including an outer surface flushing with the upper and the lower and the side surfaces of the plug body respectively, the front portion of the plug body including a first socket provided between the legs, for plugging to the electric facility, the rear portion of the plug body including at least one second socket provided thereon, and a pair of fasteners engaged through the plug body for engaging with the electric facility and for securing the plug body to the electric facility.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a plug in accordance with the present invention;

FIG. 2 is a perspective view illustrating the operation of the plug;

FIG. 3 is a plane view illustrating the operation of the plug; and

FIG. 4 is a perspective view illustrating the other embodiment of the plug.

### DETAILED DESCRIPTION OF THE PREFERRED EMBODIMENT

Referring to the drawings, and initially to FIGS. 1-3, a plug in accordance with the present invention comprises a plug body 4 including a front end or a front portion 40 having four corners and having four legs 5 extended forwardly from the four corners thereof respectively for engaging with the electric facility, particularly the computer 9. The plug body 4 includes a socket or one or more prongs 3 provided on the front portion thereof for plugging or for engaging with the corresponding typical plug or socket of the electric facility 9. The prongs 3 are provided between the legs 5 and are preferably extended forwardly of the plug body 4 or extended forwardly beyond the legs 5, for plugging into the electric facility or the computer 9.

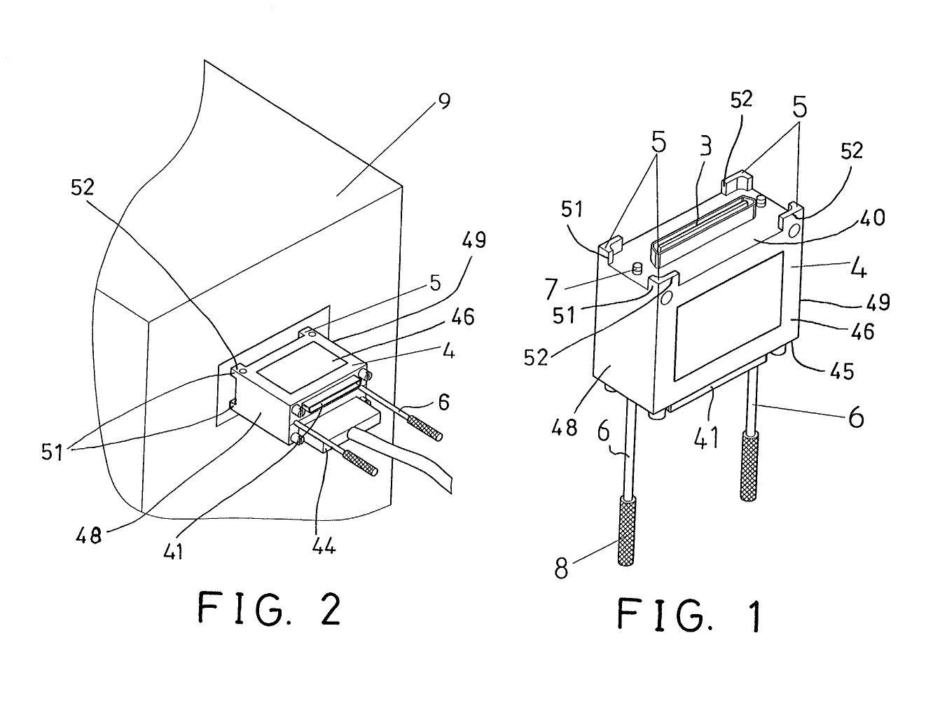

Two bolts or rods 6 are threaded or engaged through the plug body 4 and each includes a threaded front end 7 provided thereon for engaging or threading with the computer 9 and for securing the plug body 4 to the computer 9. The rods 6 each includes a knurled hand grip 8 formed thereon for facilitating the rotation of the rod 6. The plug body 4 includes one or more sockets 41, 42 provided on the rear portion thereof for receiving or for engaging with various kinds of plugs 44 (FIG. 2). Alternatively, as shown in FIG. 4, the plug body 4 may include one or more electric wires 43 coupled thereto instead of the sockets 41, 42.

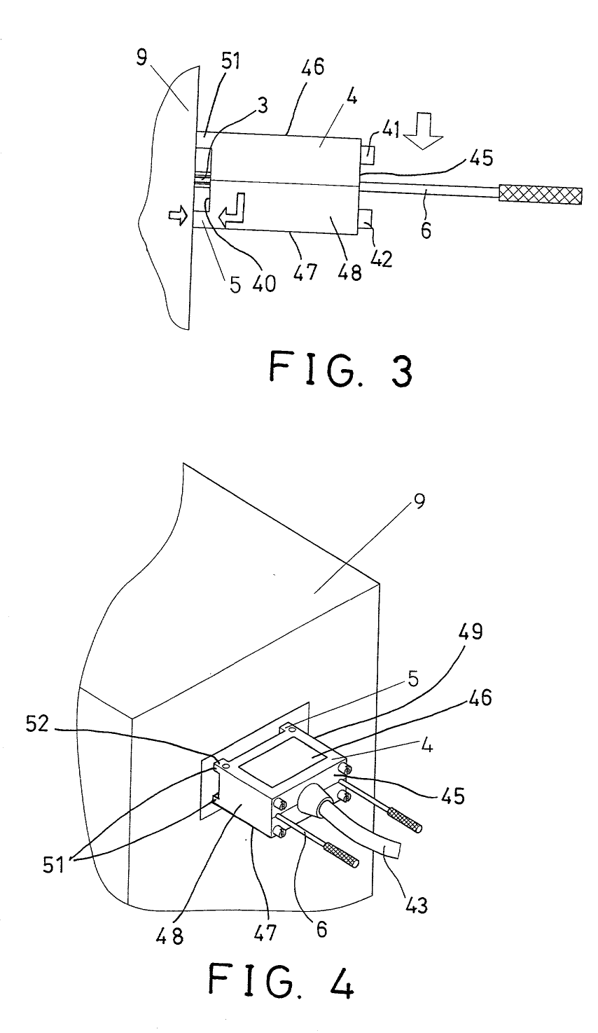

As shown in FIG. 3, when the socket or the prongs 3 of the plug body 4 are plugged or engaged with the corresponding typical plug or socket of the electric facility 9, the legs 5 that are provided in the four corners of the front portion of the plug body 4 may also be engaged with the electric facility 9, such that the prongs 3 and the legs 5 form a stable plan and a stable structure for allowing the plug body 4 to be stably engaged onto the electric facility 9. The legs 5 include a relatively smaller area or a limited area in contact with the electric facility 9; i.e., the plug body 4 has only the relatively smaller legs 5 engaged with the electric facility 9 and is not required to have the whole area of the front portion thereof to engage with the electric facility 9.

As best shown in FIG. 1, the legs 5 are L-shaped, or each includes an L-shaped cross section having two limbs 51, 52 perpendicular to each other. The limbs 51, 52 include an outer surface flush with the upper surface 46 and/or the lower surface 47 and/or the side surfaces 48, 49 of the plug body 4. Or, the legs 5 each includes an L-shaped front end for engaging with the electric facility, particularly the computer 9. The four L-shaped front ends of the legs 5 form a further stable structure for attaching the socket 3 of the plug body 4 onto the electric facility 9.

Accordingly, the plug in accordance with the present invention includes four L-shaped legs extended from the four corners thereof for stably engaging with the computer.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A plug device for an electric facility, said plug device comprising:
a plug body including a front portion, a rear portion, an upper surface, a lower surface, and two side surfaces,
said plug body including four corners having four legs extended forwardly from said four corners thereof respectively for engaging with the electric facility, said legs each including an L-shaped cross section having a pair of limbs perpendicular to each other respectively, and said limbs of said legs including an outer surface flushing with said upper and said lower and said side surfaces of said plug body respectively,
said front portion of said plug body including a first socket provided between said legs, for plugging to the electric facility,
said rear portion of said plug body including at least one second socket provided thereon, and
a pair of fasteners engaged through said plug body for engaging with the electric facility and for securing said plug body to the electric facility.
